(19) United States
(12) Patent Application Publication
(10) Pub. No.: US 2011/0146302 A1
(43) Pub. Date: Jun. 23, 2011

(54) CRYOGENIC HEAT EXCHANGER FOR THERMOACOUSTIC REFRIGERATION SYSTEM

(76) Inventors: Michael D. Newman, Hillsborough, NJ (US); Stephen A. McCormick, Warrington, PA (US)

(21) Appl. No.: 12/642,994

(22) Filed: Dec. 21, 2009

(51) Int. Cl. F25B 9/00; F17C 9/02

(52) U.S. Cl. 62/6; 62/50.2

(57) ABSTRACT

A heat exchanger and related method for a thermoacoustic refrigeration system are provided, which includes a warm end of the heat exchanger, a cryogen passing through the warm end to remove heat generated by a thermoacoustic wave generator, and a cool end through which a cooling medium passes to be cooled by the heat transfer at the warm end, wherein cryogenic gas is exhausted from the warm end, and a cooling gas is exhausted from the cool end at a lower temperature than a temperature of the warm end.

The present apparatus and methods are related to heat exchangers and refrigeration systems used with for example with food products.

In known thermoacoustic refrigeration systems, warm and cold temperatures may be formed at opposed ends of a heat exchanger stack for the system. Heat exchangers are usually disposed at either end of the stack to transfer heat away from the process and to distribute cooling to a system which requires refrigeration and hence there is provided a “warm end” and a “cold end” of the stack. A temperature differential in the stack or the ability of the refrigeration system to achieve colder temperatures is dictated by the ability of the heat exchanger at the warm end to remove system heat. Known systems use at the warm end air and water for example as a means of cooling to remove heat from the stack.

For a more complete understanding of the present embodiments, reference may be had to the following drawings taken in connection with the description of the embodiments, of which:

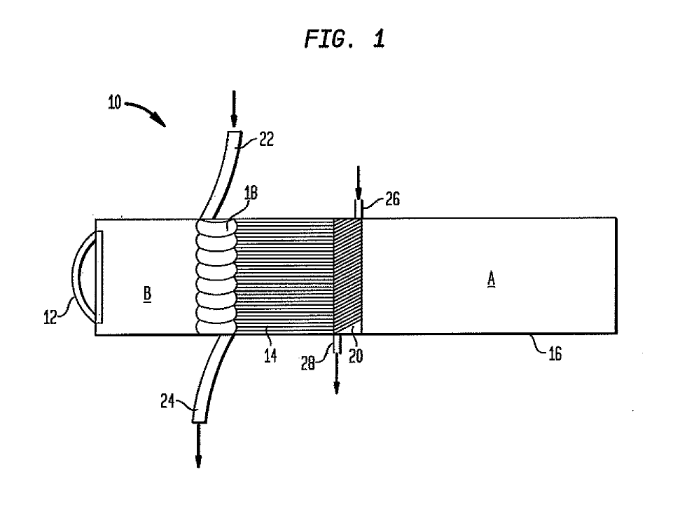

FIG. 1 shows a schematic of a thermoacoustic device with an acoustic wave generator using cryogenic cooling for the heat exchanger.

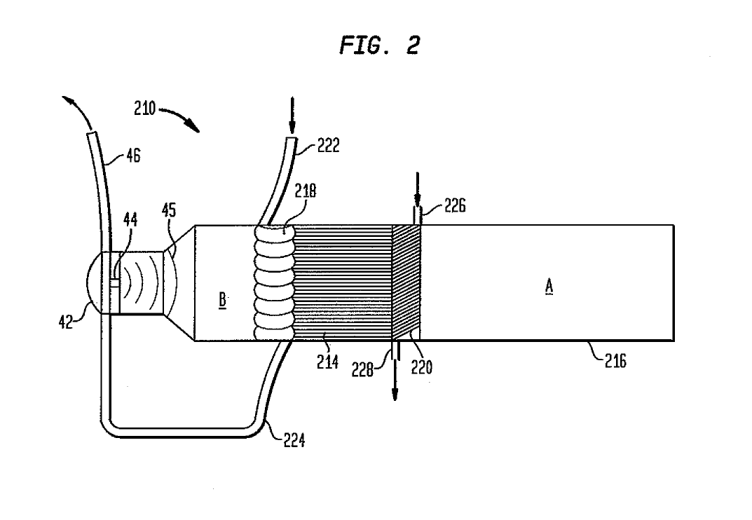

FIG. 2 shows a schematic of another embodiment of a thermoacoustic device.

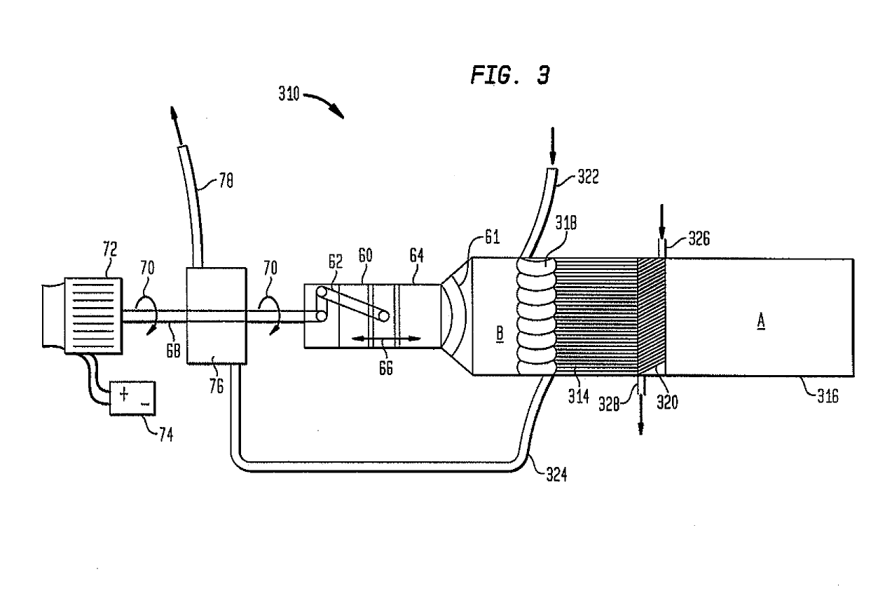

FIG. 3 shows a schematic of still another embodiment of a thermoacoustic device.

In FIG. 1, there is shown a thermoacoustic device 10 with an acoustic wave generator 12, a regenerator stack 14, a resonator tube 16 and both warm and cold end heat exchangers 18, 20 respectively at opposed ends of the stack 14. The resonator tube consists of a primary resonator portion “A” and secondary resonator portion “B”. Cryogenic liquid, such as liquid nitrogen, is used to remove heat from the warm end 18 of the regenerator stack 14. As a result, the cold end 20 heat exchanger of the stack 14 can operate at temperatures well below that of the warm end or even of the liquid or gaseous cryogen.

In the present embodiments, a liquid or gaseous cryogen, such as for example carbon dioxide, nitrogen, argon or liquid air, is introduced at an inlet of a pipe or conduit 22 and passed through the warm end heat exchanger 18 to cool the cool end 20 of the stack 14. The cryogen used with the heat exchanger 18 cools the warm end of the stack 14 which has been heated from the acoustic waves of the wave generator 12. Such cryogen provides temperatures much colder than that which can be realized in heat exchange of known systems. The warming and expansion of the cryogenic fluid in the heat exchanger 18 results in a cryogenic gas being emitted at an outlet pipe 24 of the heat exchanger 18.

At the cold end heat exchanger 20, a cooling fluid which can be cryogen but can also be air, helium, glycol, argon, oxygen or other fluid used for cooling, is introduced in liquid or gaseous phase at inlet pipe 26 so that the fluid is cooled at the heat exchanger 20 and removed at outlet 28 of the heat exchanger 20 to be used for a refrigeration process for example. In effect, the cryogen introduced at the inlet pipe 22 is used to remove heat from the stack 14, while at the same time substantially cooling the fluid introduced at inlet 26 so that same can be used in subsequent refrigeration or cooling processes after it has been emitted from the heat exchanger 20 through the outlet pipe 28. The cryogenic liquid being used at least at the heat exchanger 18 provides for substantially cooling fluid at the heat exchanger 20 for such refrigeration processes. The temperature of the fluid in the outlet pipe 28 can be 100°-150° F. colder than the temperature of the cryogen at the heat exchanger 18.

The temperature differential in the stack 14 or the ability of the device 10 to reach colder temperatures is realized by the use of the cryogenic fluid introduced at the pipe 22. Sound waves generated by the acoustic wave generator 12 are always moving in the stack 14 and therefore, such movement provides an increase in heat which must accordingly be controlled and reduced by use of the heat exchanger 18. To accommodate at least the reduced temperatures of the cryogenic fluid, the heat exchanger 18 is constructed from a highly conductive material such as monocrystalline synthetic diamond, which material has the highest thermal conductivity of any known solid at room temperature, i.e. 2,000-2,500 W m/m2 K (200-250 W mm/cm2 K). At these lower temperatures, conductivity becomes more effective and more efficient as Fermi electrons can match the phononic normal transport mode near the Debye point, and transport heat more swiftly, to overcome the drop of specific heat with the fewer quantal microstates, to reach 41,000 W m/m2 K at 104° K (Kelvin). This is only one example of possible heat exchanger materials. Any highly conductive material can be used. However, the greater the thermal conductivity of the material the more effective the process. Copper or copper-nickel alloys can also be used for at least the heat exchanger 18.

Two other exemplary embodiments of the present apparatus and methods are illustrated in FIGS. 2 and 3. Elements illustrated in FIGS. 2 and 3 which correspond to elements described above with respect to FIG. 1 have been designated by corresponding reference numerals increased by 200 and 300, respectively. The embodiments of FIGS. 2 and 3 are constructed and designed for use in the same manner as the embodiment of FIG. 1, unless otherwise stated.

Referring now to FIG. 2, an outlet pipe 224 of the heat exchanger 218 is provided which exhausts a cryogenic gas from a hot end of the heat exchanger 218 for powering an acoustic wave generator, such as a sound-type acoustic wave generator 42. The acoustic wave generator 42 is attached or made part of the resonator tube 216 at for example the secondary portion B. The outlet pipe 224 extends into the acoustic wave generator 42 for powering same. The high pressure gas which is exhausted and provided by the outlet pipe 224 to the generator 42 is used in conjunction with a specifically sized orifice 44 which provides a passageway from an interior of the pipe 224, where the gas is, to the resonator tube 216 to produce high-powered sound waves 45. The sound waves are provided to the regenerator stack 214 which provides the power necessary for a thermal acoustic refrigeration cycle. Only a small portion of the gas in the pipe 224 is passed through the orifice 44 into the resonator tube 216.

In the embodiment of FIG. 2, system efficiency is improved as the high pressure cryogen gas, such as a nitrogen gas, is used to generate energy to drive the apparatus and is exhausted at a much lower pressure. Any cryogen gas remaining in the pipe 224 which has not been bled through the orifice 44 is removed as exhaust through outlet pipe 46, which exhaust may be recycled or used for subsequent processing. In effect, use of the waste gas in pipe 224 is used to drive the device 210. Similar to FIG. 1, the heat transfer fluid at the pipe 228 is at a temperature considerably lower (100°-150° F. lower) than the temperature of the cryogen fluid in the heat exchanger 218. The coolant fluid or medium can be at least one of cryogen, air, helium, glycol, argon or oxygen.

Referring to FIG. 3, liquid or gaseous cryogen such as liquid nitrogen is provided at the pipe 322 to be passed through the heat exchanger 318 and discharged to the outlet pipe 324, where it is used to power a piston-type acoustic wave generator 60. This acoustic wave generator 60 provides high power sound waves 61. A piston assembly 62 is disposed within an enclosed tube 64 of the generator 60. Arrow 66 indicates the reciprocating movement of the piston assembly 62.

A drive shaft 68 is constructed and arranged for rotational movement as indicated by arrows 70, and is coupled at one end to the piston assembly 62 and, at an opposed end to an electric motor 72. The electric motor is connected to and obtains power from a power source 74.

Interposed between the generator 60 and the electric motor 72 is a gas motor 76 into which the exhaust from the pipe 324 is introduced. The gas motor 76 is also connected to the drive shaft 68. The high pressure nitrogen gas is used to power the gas motor and provide mechanical energy for the process. The gas motor 76 is also mechanically connected to the drive shaft 68 to rotate same. That is, electric motor 72 and the gas motor 76 coact to rotate the shaft 68. In effect, use of the gas motor 76 reduces the power demand of the electric motor 72 in order to rotate the shaft 68, thereby reducing the cost to operate the electric motor 72 and to generate the sound waves 61. As shown in FIG. 3, when the shaft 68 is rotated, such rotation actuates the piston assembly 62 such that the generator 60 provides the sound waves 61 for the stack 314. Any remaining nitrogen gas not used by the gas motor 76 is exhausted through pipe 78. The temperature of the fluid 328 can be as much as 100°-150° F. lower than the temperature of the cryogen fluid in the heat exchanger 318.

For all embodiments discussed above, the cryogenic fluid can be selected from carbon dioxide, nitrogen, argon and liquid air. The coolant fluid or medium introduced to the cool end of the heat exchanger can be a cryogen as well, or can be selected from any type of coolant fluid, such as for example air, helium, glycol, argon, oxygen. The heat exchangers 218, 318 at least may also be constructed from the same materials as the heat exchanger 18.

The present embodiments provide for colder operating temperatures at heat exchangers and refrigeration systems to which they are connected. As a result, the overall efficiency of the freezing process is realized.

It will be understood that the embodiments described herein are merely exemplary, and that one skilled in the art may make variations and modifications without departing from the spirit and scope of the embodiments. All such variations and modifications are intended to be included within the scope of the embodiments as described and claimed herein. Further, all embodiments disclosed are not necessarily in the alternative, as various embodiments may be combined to provide the desired result.

What is claimed is:

1. A heat exchanger for a thermoacoustic refrigeration system, comprising:
a warm end of the heat exchanger, a cryogen passing through the warm end to remove heat generated by a thermoacoustic wave generator, and a cool end through which a cooling medium passes to be cooled by the heat transfer at the warm end, wherein cryogenic gas is exhausted from the warm end, and a cooling gas is exhausted from the cool end at a lower temperature than a temperature of the warm end.

2. The heat exchanger of claim 1, wherein the cryogen introduced into the warm end of the heat exchanger is at least one of cryogenic gas or cryogenic liquid.

3. The heat exchanger of claim 2, wherein the cryogenic gas at least one of gaseous carbon dioxide, gaseous nitrogen or gaseous argon.

4. The heat exchanger of claim 2, wherein the cryogenic liquid at least one of liquid carbon dioxide, liquid nitrogen or liquid argon.

5. The heat exchanger of claim 1, wherein the cooling medium introduced into the cool end of the heat exchanger is at least one of cryogen, air, helium, glycol, argon or oxygen.

6. The heat exchanger of claim 1, wherein the heat exchanger is constructed from monocrystalline synthetic diamond material.

7. The heat exchanger of claim 1, wherein the thermoacoustic wave generator comprises a sound-power wave generator, and the warm end of the heat exchanger comprises an outlet pipe for providing the cryogenic exhaust gas from the heat exchanger to the sound-powered wave generator for operation thereof.

8. The heat exchanger of claim 1, wherein the thermoacoustic wave generator comprises a piston-type wave generator, and the warm end of the heat exchanger comprises an outlet pipe for providing the cryogenic exhaust gas from the heat exchanger to the piston-type wave generator for operation thereof.

9. A method for cooling a heat exchanger for a thermoacoustic refrigeration system, comprising;
passing a cryogen through a warm end of the heat exchanger for transferring heat for a refrigeration process;
providing cryogenic exhaust from the warm end of the heat exchanger to a wave generator of the thermoacoustic refrigeration system;
providing a cooling medium to a cool end of the heat exchanger such that a temperature of the cooling medium is reduced upon exposure to the heat transfer by the cryogen to be at a temperature lower than a temperature of the cryogen.

10. The method of claim 9, wherein the step of passing comprises introducing the cryogen into an inlet of the heat exchanger and exhausting cryogen gas from an outlet of the heat exchanger.

11. The method of claim 9, wherein the cryogen is at least one of cryogenic gas or cryogenic liquid.

12. The method of claim 11, wherein the cryogenic gas is at least one of gaseous carbon dioxide, gaseous nitrogen or gaseous argon.

13. The method of claim 11, wherein the cryogenic liquid is at least one of liquid carbon dioxide, liquid nitrogen or liquid argon.

14. The method of claim 9, wherein the cooling medium is at least one of cryogen, air, helium, glycol, argon or oxygen.

15. The method of claim 10, further comprising providing the exhausted cryogenic gas to a wave generator for the thermoacoustic refrigeration system.

16. The method of claim 10, further comprising providing the exhausted cryogenic gas to a gas motor for the thermoacoustic refrigeration system.

17. The method of claim 9, wherein the heat exchanger is constructed from monocrystalline synthetic diamond material.
